(19) United States
(12) Patent Application Publication
(10) Pub. No.: US 2026/0185624 A1
(43) Pub. Date: Jul. 2, 2026

(54) HEAT RESPONSIVE VALVE AND HEAT RESPONSIVE MANIFOLD FOR FLUIDS, WITH THERMAL BYPASS AND INTEGRAL OVERPRESSURE RELIEF FUNCTION

(71) Applicant: Ausco, Inc., Farmingdale, NY (US)

(72) Inventors: Thomas TAYLOR, Watertown, CT (US); Matthew Joseph RUGGIERO, Medford, NY (US)

(21) Appl. No.: 19/421,325

(22) Filed: Dec. 16, 2025

Related U.S. Application Data
(60) Provisional application No. 63/735,090, filed on Dec. 17, 2024.

(51) Int. Cl. F16K 17/04; F16K 17/38

(52) U.S. Cl. CPC F16K 17/048; F16K 17/38; F16K 2200/401

(57) ABSTRACT

Disclosed are heat responsive control valves, and heat responsive control manifolds, having thermal bypass and integral overpressure relief functionality, as well as methods for their use.

The present invention relates to a heat responsive control valve comprising in addition to a control function also an integral overpressure relief function. In a further embodiment, there is provided a heat responsive control manifold, useful in the controlled dispensing of fluids therefrom comprising, in addition to a control function also an integral overpressure relief function.

The control of fluids (i.e., gases, but especially fluids) is essential in a multitude of technical applications and various apparatus widely used in our world. Each apparatus and process will of course impose its own particular technical parameters necessary for effective control. In the case of control of fluids, particular technical considerations often arise, in providing effective control particularly over a long service life, including effective control of fluid control circuits and maintenance of safe operation of an apparatus used in a technical application. Technical applications and apparatus which may benefit from the use of a heat responsive control valve, and/or a heat responsive control manifold, include, i.e., medical, aerospace, oil and gas drilling, heating, cooling, environmental control and similar applications. The heat responsive valve for fluids and heat responsive manifold for fluids provided by the invention, as well as processes/methods utilizing the same, provide solutions in such technical applications.

In a first aspect there is provided a heat responsive control valve comprising a body having at least one interior upper cavity, at least one interior lower cavity and a valve port intermediate the cavities, a fluid input port and a fluid output port in fluid communication with at least one of the cavities, a retractable poppet stem having at or near one end, a poppet nut, and at or near another end, a poppet which when the poppet is engaged against the valve port closes the valve port, housing, a poppet guide moveable within the housing, the poppet guide having poppet guide bore within which the poppet stem is slidably engaged, a thermal actuator between the poppet and the poppet guide, and further within the housing, a pressure relief spring, a relief spring retainer, and a bias spring, wherein the bias spring is moveable within the interior of the relief spring retainer and is present between the poppet guide and the poppet nut, the pressure relief spring is moveable within the housing and is present between the exterior of the relief spring retainer and the housing, which heat responsive control valve, may under different internal temperature and pressure conditions, assume one of four different operational configurations. The heat responsive control valve also provides an integral overpressure relief function, and may be configured in response to an overpressurized state to assume a bypass configuration.

In a second aspect there is provided a heat responsive control manifold, which incorporates features of the heat responsive control valve described in the first aspect, but which further includes more than one fluid input and/or more than one fluid output to one or more of the at least one interior upper cavity, and/or the at least one interior lower cavity. Preferably the one or both of the at least one upper cavity and/or the at least one lower cavity is in fluid communication with two fluid ports. Similarly to the heat responsive control valve described above, further present in the body having at least one interior upper cavity, at least one interior lower cavity is a valve port intermediate the cavities, a fluid input port and a fluid output port in fluid communication with at least one of the cavities, (preferably both fluid input port and a fluid output port in fluid communication with each of the at least one upper cavity and the at least one lower cavity) at least one a retractable poppet stem having at or near one end, a poppet nut, and at or near another end, a poppet which when the poppet is engaged against the valve port closes the valve port, housing, a poppet guide moveable within the housing, the poppet guide having poppet guide bore within which the poppet stem is slidably engaged, a thermal actuator between the poppet and the poppet guide, and further within the housing, a pressure relief spring, a relief spring retainer, and a bias spring, wherein the bias spring is moveable within the interior of the relief spring retainer and is present between the poppet guide and the poppet nut, the pressure relief spring is moveable within the housing and is present between the exterior of the relief spring retainer and the housing, which heat responsive control valve, may under different internal temperature and pressure conditions, assume one of four different operational configurations. The heat responsive control valve of the heat responsive control manifold also provides an integral overpressure relief function, and may be configured in response to an overpressurized state to assume a bypass configuration.

In a third aspect there is provided a method of controlling a flow of fluid utilizing a heat responsive control valve according to the first aspect of the invention.

In a fourth aspect there is provided a method of controlling a flow of fluid utilizing a heat responsive control manifold according to the second aspect of the invention.

In a fifth aspect there is provided a heat responsive control valve or a heat responsive control manifold having an adjustable integral overpressure relief function.

In a sixth aspect there is provided an apparatus comprising, or an apparatus which operates with, a heat responsive control valve according to one or more of the foregoing aspects of the invention.

In a seventh aspect there is provided an apparatus comprising, or an apparatus which operates with, a heat responsive control manifold according to one or more of the foregoing aspects of the invention.

These and further aspects, as well as various embodiments of the invention are better understood from the following specification and accompanying drawings, comprising figures which form an integral part of this application. Certain preferred embodiments of heat responsive control valve or heat responsive control manifold are discussed with reference to the accompanying figures, which form an integral part of this application. In the various drawing figures, presenting various embodiments and views, reference numbers a/o letters a/o labels are used consistently with reference to these drawings.

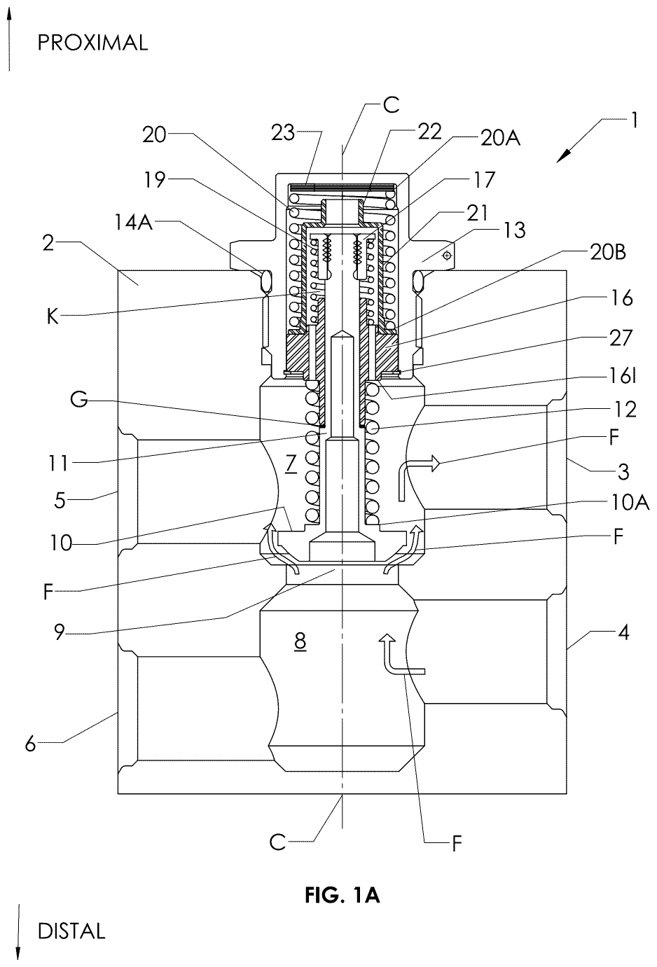

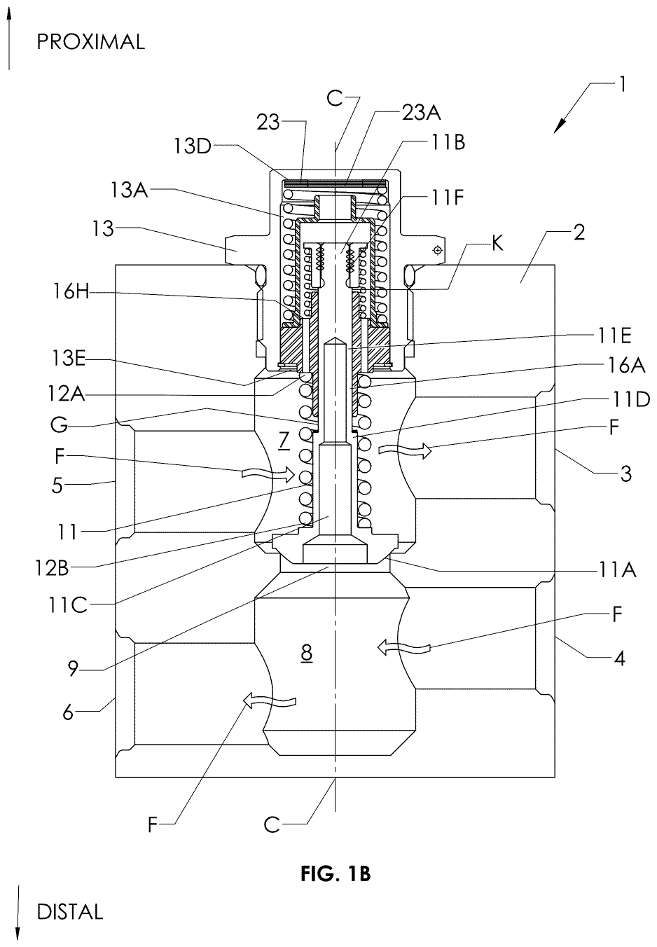

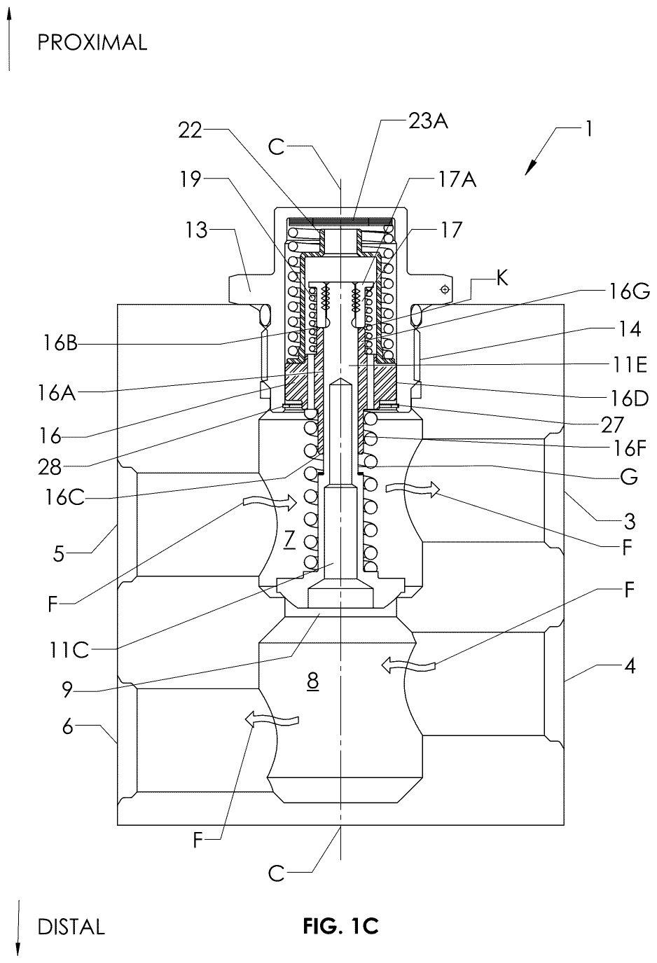

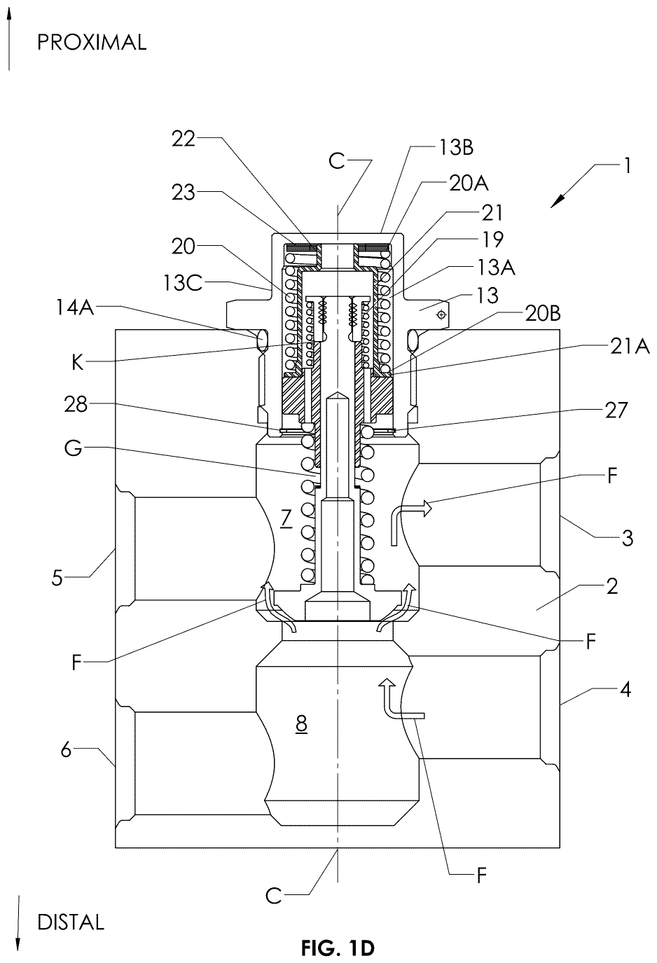

FIG. 1A depicts as embodiment of a heat responsive control manifold according to the invention in a first configuration.

FIG. 1B depicts an embodiment of a heat responsive control manifold of FIG. 1A in a second configuration.

FIG. 1C depicts an embodiment of a heat responsive control manifold of FIG. 1A in a third configuration.

FIG. 1D depicts an embodiment of a heat responsive control manifold of FIG. 1A in a fourth configuration.

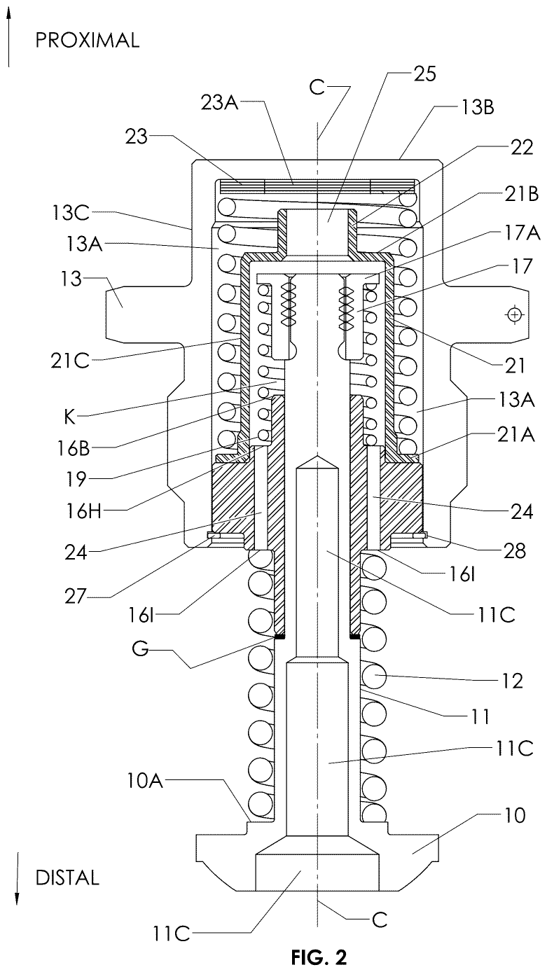

FIG. 2 provides an enlarged view of a poppet, poppet stem, housing, pressure relief spring retainer.

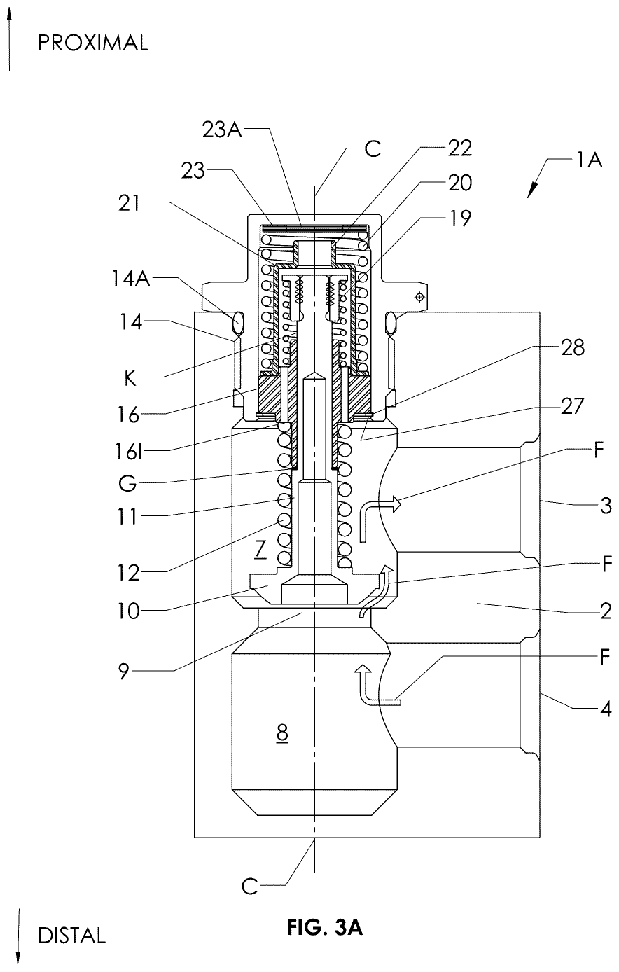

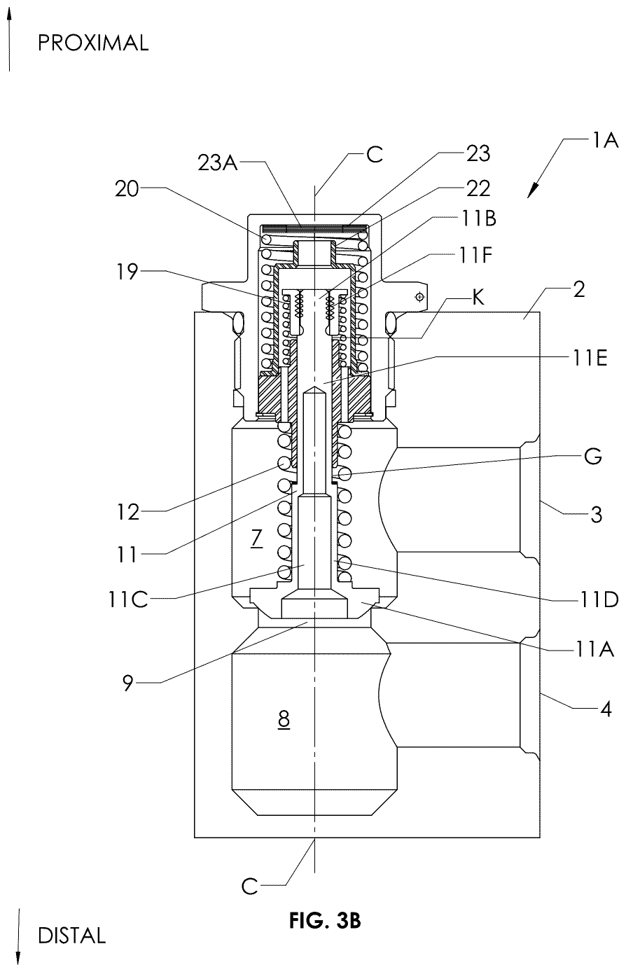

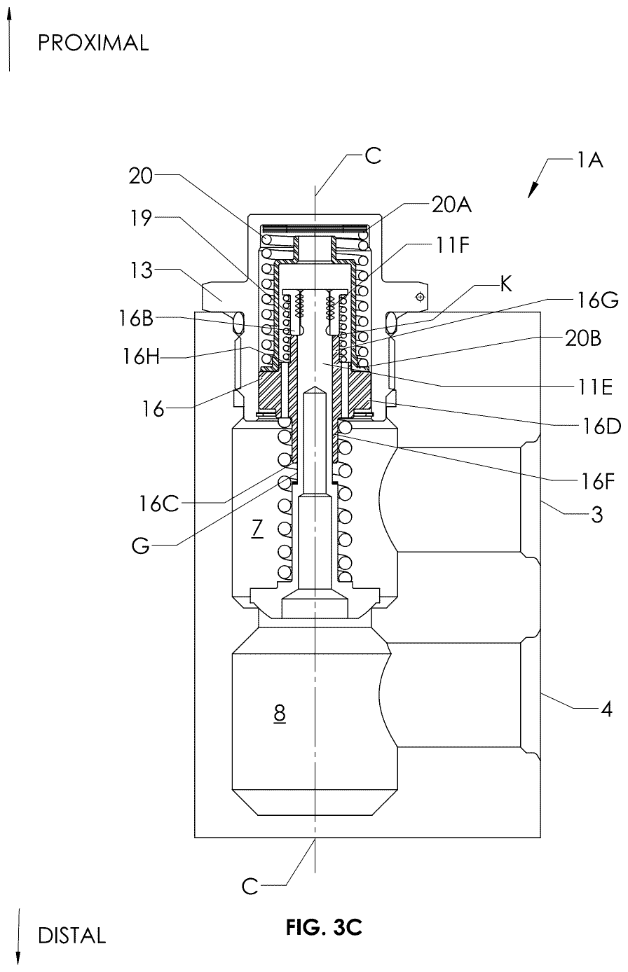

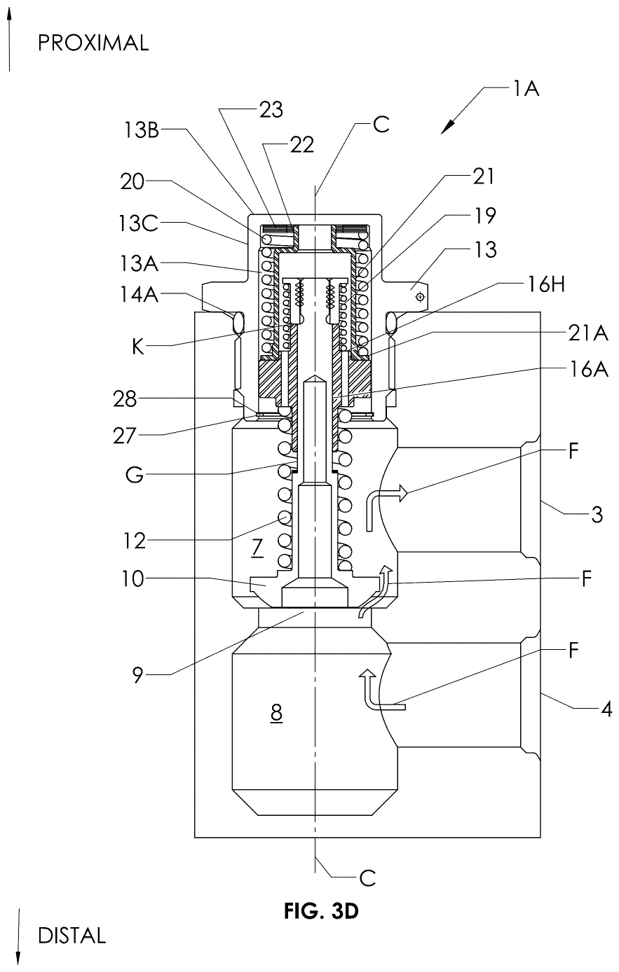

FIG. 3A depicts as embodiment of a heat responsive control manifold according to the invention in a first configuration corresponding to a first operating state.

FIG. 3B depicts as embodiment of a heat responsive control manifold according to the invention in a second configuration corresponding to a second operating state.

FIG. 3C depicts as embodiment of a heat responsive control manifold according to the invention in a third configuration corresponding to a third operating state.

FIG. 3D depicts as embodiment of a heat responsive control manifold according to the invention in a fourth configuration corresponding to a fourth operating state.

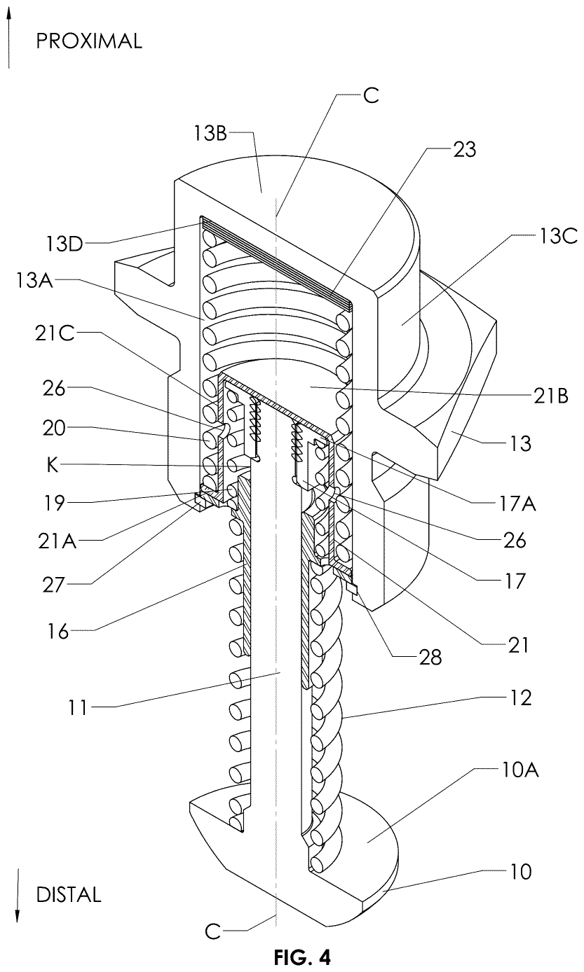

FIG. 4 depicts an alternative view of certain elements which may used with any embodiment of a heat responsive control manifold such as illustrated on FIGS. 1A-1D, or with a heat responsive control valve such as illustrated of FIGS. 3A-3D,

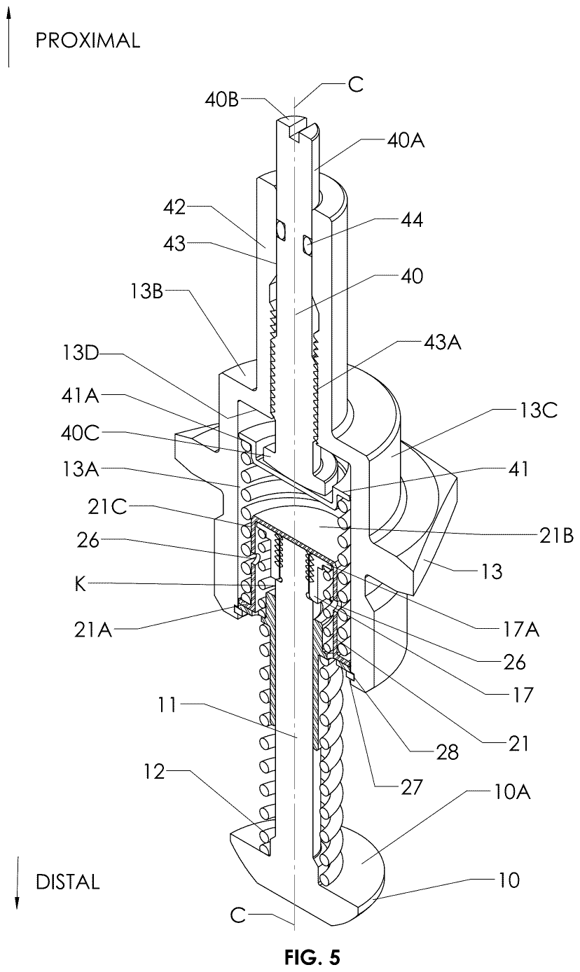

FIG. 5 depicts a further alternative view of certain elements which may used with any embodiment of a heat responsive control manifold such as illustrated on FIGS. 1A-1D, or with a heat responsive control valve such as illustrated of FIGS. 3A-3D,

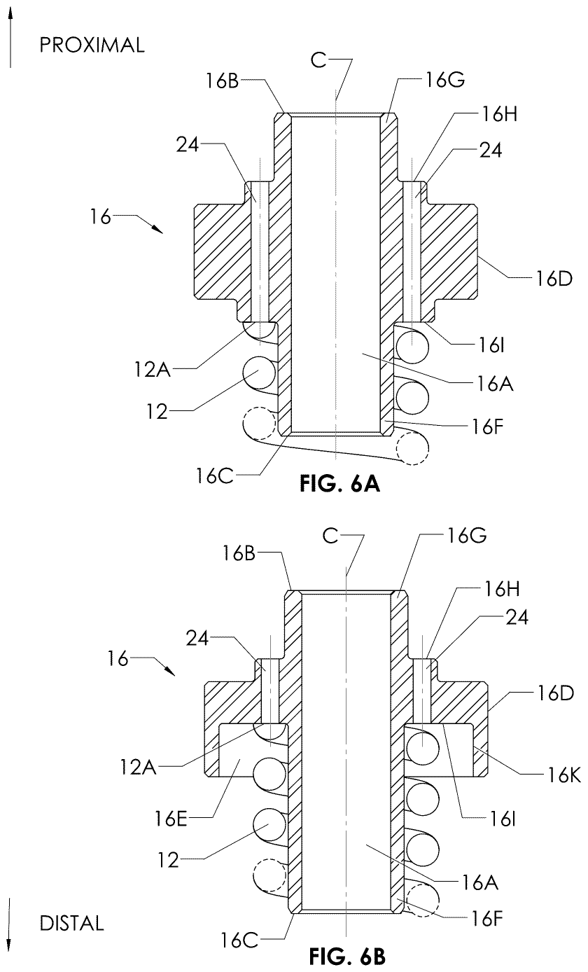

FIG. 6 a depicts a first configuration of a poppet.

FIG. 6B depicts a second configuration of a poppet.

With respect to the definition of heat responsive control valve, such as is discussed with regard to the first aspect of the invention as well as hereinafter, a heat responsive control manifold as discussed with respect to the second aspect of the invention, both necessarily includes one or more essential components of a heat responsive control valve within its construction. Also, it is to be further appreciated that a heat responsive control manifold may include one, two, three or more heat responsive control valves which may function independently of one another, or function in the same manner, within a heat responsive manifold of which the one, two or more heat responsive control valves form an integral part. It is thus to be understood that a heat responsive control manifold is a superset of heat responsive control valve, i.e., in that it additionally may include more than one fluid input, more than one fluid output, or both of the aforesaid.

The fluid used with and/or controlled by the heat responsive control valve a/o heat responsive control manifolds according to the invention, particularly in the embodiments disclosed and discussed herein are may be gases, or non-gas fluids, and in certain preferred embodiments are incompressible or substantially incompressible liquids.

Each embodiment of a heat responsive control valve, or heat responsive control manifold, necessarily comprises a heat responsive element. the heat responsive element, a shape-memory metal alloy, particularly where it is Nitinol, when it is heated to a target, or so-called elevated temperature (or temperature range), the atoms arrange themselves into a cubic, highly symmetrical arrangement known as the austenite phase. After the heat responsive element has cooled down, the piece will enter the martensite phase and can be deformed into various shapes. When the heat responsive element is reheated to the austenite phase (a transition temperature that varies with the particular shape-memory metal alloy) the heat responsive element will “remember” the original or parent shape and exert a great force to return to that shape if the piece is in anyway constrained from returning. All of these phase changes occur while the Nitinol remains a solid, only the crystal structure changes as described.

Nitinol is typically composed of approximately 55% nickel and 45% titanium by weight, but other relative amounts of nickel and titanium may also be utilized, namely may be wherein the atomic percentages of both metals are equal or nearly equal, preferably where nickel is within +/−20% of titanium. Further metals may be present, but if present are usually in substantially lesser concentrations than the nickel and titanium which comprise the bulk of the Nitinol material. The control of the relative atomic ratios (concentrations) of nickel and titanium permits for a degree of control of the transition temperature of the Nitinol, and allows for the actuation temperature to be tailored for the application. In the context of the present invention, the composition of the heat responsive element is such that the rearrangement of atoms to the austenite phase occurs when the heat responsive element is in the range of about 60° C. to about 93.5° C. (approx. 140° F. to about 200° F.). The maximum operating temperature for Nitinol actuators is typically about 150° C. (approx. 302° F.), and most Nitinol actuators begin their phase transformation at approximately 75° C. (approx. 167° F.), although lower phase transformation temperatures are also possible, with activation temperatures or phase transformation temperatures of about 50° C. (approx. 122° F.) or higher temperatures, i.e., about 60° C. (approx. 140° F.). about 70° C. (approx. 158° F.), about 80° C. (approx. 176° F.) and about 90° C. (approx. 194° F.), which phase transformation temperatures may be established by the composition of the Nitinol alloy and the amounts of nickel and titanium present within the alloy, as well as the dimensions (including the diameter of the wire of a coiled spring type configuration of a Nitinol actuator) As to heat responsive elements formed using or of Nitinol which are in a coiled spring type configuration, their performance is based on their composition as well as their dimensions and in the present invention, any configuration is contemplated as being useful and are not limited to a coiled spring type configuration of a Nitinol actuator as depicted in the drawings. Also, the operational range of a coiled spring type configuration of a Nitinol actuator, preferred for use in the present invention may have any operational temperature which does not exceed the limits of temperature and stress limits of a coiled spring type configuration of a Nitinol actuator so that it is no longer reversible in shape, i.e., that the stress limits and/or temperature limits of the a coiled spring type configuration of a Nitinol actuator are not irreversibly exceeded. Generally reversible operation of the a coiled spring type configuration of a Nitinol actuator, as preferred for use in the present invention is preferably in the range of about 20° C. (approx. 68° F.), to about 170° C. (approx. 338° F.), but preferably has a lower operational temperature of about 50° C. (approx. 122° F.), preferably about 60° C. (approx. 140° F.), or about 70° C. (approx. 158° F.), and an upper operational temperature of about 150° C. (approx. 302° C.), preferably not in excess of about 125° C. (approx. 257° F.). In certain preferred embodiments the lower and upper operational limits of the heat responsive element, is in the range of about 60° C. (approx. 140° F.) to about 95° C. (approx. 200° F.). However, the operational limits of the upper and lower operating temperatures of the heat responsive element formed of or comprising Nitinol may be any of the temperatures disclosed in this paragraph, or otherwise disclosed in this specification.

The remaining component parts of the heat responsive control valve or heat responsive control manifold may be any suitable material which will fulfill the necessary purpose and meet the operations expected. Coming into consideration are metals, metal alloys, synthetic polymer, ceramics, etc.

Certain preferred embodiments of heat responsive control valve and heat responsive control manifold are discussed with reference to the accompanying figures, which form an integral part of this application. In the various drawing figures, presenting various embodiments and views, reference numbers a/o letters a/o labels are used consistently with reference to these drawings.

FIGS. 1A-1D depict a preferred embodiment of a heat responsive control manifold 1 according to the invention. Each of the drawings 1A, 1B, 1C, and 1D depict different operational states of the heat responsive control manifold 1 at different temperature and pressure conditions, including an overpressure condition, as will be described in more detail hereinafter.

The heat responsive control manifold 1 comprises a body 2, having included therein an upper cavity 7, and a lower cavity 8. The upper cavity 7 is in fluid communication with port 3 and with port 5 whereby fluid may flow into and out of the upper cavity 7 through one or both of these ports 3, 5, as well as transit (“flow”, “fluid flow”) between ports 3, 5 via the upper cavity 7. Similarly, the lower cavity 8 is in fluid communication with further ports, port 4 and port 6, and similarly fluid may flow into and out of the lower cavity 8 through one or both of these ports 4, 6, as well as transit between ports 4, 6. Intermediate the upper cavity 7 and the lower cavity 8 is provided a valve port 9 which when in an ‘open’ state allows for fluid communication between the upper cavity 7 and lower cavity 8. The valve port 9 may be alternately in an “open” or “closed” state, correspondingly permitting and denying, the passage of fluid between the upper cavity 7 and lower cavity 8. Valve port 9 can be open and closed by the interaction of a poppet 10 which may in certain positions, be separated from the valve port 9, thereby allowing fluid flow. Alternately a portion of the poppet 10 may be seated against the valve port 9 thereby closing the valve port 9, and denying passage of fluid flow through the valve port 9 and between the upper cavity 7 and the lower cavity 8. The poppet 10 depends from or may be integrally formed as part of a poppet stem 11 which stem includes the poppet 10 at or near a distal end thereof 11A, and at an opposite, proximal end 11B is engaged a poppet nut 17. In the present embodiment, the engagement of the poppet nut 17 with the proximal end 11B occurs through the use of mating threads 11F. The poppet stem 11 is preferably, generally cylindrical and has a central axis “C” which is coincident or concentric with both the poppet 10, and the poppet stem 11. In a preferred embodiment, as shown, the poppet 10 and poppet stem 11 is not solid in its interior but includes a poppet stem cavity 11C which is provided by one or more bores which are generally concentric about the central axis C, which poppet stem cavity 11C reduces the mass of the poppet 10 and poppet stem 11 which may improve the thermal response time of the heat responsive control manifold 1. While the inclusion of a poppet stem cavity 11C is preferred as the reduced mass also reduces inertia when the position of the poppet 10 and poppet stem 11 is translated within the poppet guide 16, such is not required in all embodiments as is later discussed. However an additional advantage of a poppet stem cavity 11C is that it may be used to provide for better homogeneity in the thermal mass distribution of the poppet 10 and poppet stem 11 between its ends, viz., between its distal end 11A and its proximal end 11B.

Preferably, as in the depicted preferred embodiment of drawings therein is illustrated the poppet stem 11 having along its length beyond the region of the poppet at its distal end 11A and to its proximal end 11B, a generally cylindrical configuration, also coincident with the central axis C, but having one or more regions of different diameters, here for example a larger diameter region 11D closer to the distal end 11A and a smaller diameter region 11E closer to the proximal end 11B.

A poppet guide 16 is also present. As is depicted in FIGS. 6A and 6B the poppet 16 may be of different configurations, and these may be interchangeably used in any aspect of the invention, i.e. the poppet guide 16 of FIG. 6A may be substituted by the poppet guide 16 of FIG. 16, and vice-versa. The poppet guide 16 includes a poppet guide bore 16A within which a portion of the poppet stem 11, preferably the smaller diameter region 11E, is slidingly engaged so that it may move in both the proximal and distal directions, in a manner discussed herein. The poppet guide 16 further includes a proximal end 16B, a distal end 16C which also define corresponding ends of the poppet guide bore 16A, and includes a poppet sidewall 16D extending radially outwardly from the centerline of the poppet guide 16. The poppet sidewall 16 also includes one or more poppet guide vents 24 passing through portions of the poppet sidewall 16. The poppet guide 16 is provided proximal guide region 16G, which is adjacent to or near to the proximal end 16C, as well as a distal guide region 16F which is adjacent to or near the distal end 16C. In one embodiment of the poppet 16 corresponding to FIG. 6B, between the poppet sidewall 16D and a distal guide region 16F of the poppet guide 16 is provided a poppet skirt recess 16E forming a cavity 16K within a part of the poppet guide 16. A portion of the thermal actuator 12, preferably a proximal end 12A of the thermal actuator 12 is engaged in the cavity 16K and its proximal end 12A abuts a poppet guide abutment surface 16I preset within the cavity 16K. In the alternative embodiment of the poppet 16 corresponding to FIG. 6A, no poppet skirt recess 16E is extant, but the poppet sidewall 16D provides includes poppet guide abutment surface 16I which in a similar manner abuts the proximal end 12A of the thermal actuator 12. The aforesaid portions of the poppet guide 16 are all preferably, generally concentric about the central axis C of the poppet 10 and the poppet stem 11. Again, any embodiment of the invention may include either poppet 16 described with respect to FIGS. 6A, 6B notwithstanding that most of the figures illustrate the poppet 16 of FIG. 6A.

The poppet guide 16 is retained in a housing 13 which is fitted into and retained in a housing bore 14 in a proximal part of the body 2. The housing 13 is also preferably, generally concentric, about the central axis C of the poppet 10 and poppet stem 11. The housing 13 may have a threaded (not shown) and/or an interference type fit with the housing bore 14, and if desired one or more seals, washers, or O-rings 14A can be used to provide a fluid tight, preferably a liquid tight seal, between the housing 13 and the body 2. The housing 13 further includes a housing interior 13A, which is in part defined by a housing top wall 13B, and a circumferential housing sidewall 13C, a part of the latter of which is preferably within the interior of the body 2, and a housing open end 13E. A part of the sidewall 13C in near proximity to or adjacent the housing open end 13E includes a lock ring recess 28 within which may be present a lock ring 27 which extends radially inwardly in the direction of the poppet stem 11. The lock ring 27 retains the poppet guide 16, which in turn retains the relief spring retainer 21 within the housing 13, as well as the bias spring 19 and the pressure relief spring 20 as well. Alternatives to the lock ring 27 are also contemplated, although not depicted but may be one or more inwardly directed pins, a flange, and the like. While not illustrated in any of the drawing figures, it is nonetheless to be understood that where the housing 13 may be connected to the body 2 by set of mating threads, that these can be suitably positioned at the exterior of the circumferential housing sidewall 13C and correspondingly within a part of the body 2, and advantageously is connected by such a set of mating threads. In addition to a proximal end 16B of the poppet guide 16 and the proximal guide region 16G being present within the housing interior 13A, further present within the housing interior 13A is a bias spring 19 within a pressure relief spring retainer 21 having a pressure relief spring retainer stop 22 extending from a relief spring top end face 21B, from which depends a relief spring retainer sidewall 21C from which depends a radially outwardly extending relief spring bottom flange 21A (see FIG. 2). A pressure relief spring 20 is present within the housing interior 13A, between the pressure relief spring retainer 21 and the housing sidewall 13A. Preferably the foregoing elements within the housing 13 are preferably, generally concentric about the central axis C of the poppet 10 and poppet stem 11, and all of which are in the near proximity of the proximal end 11B of the poppet stem 11.

It is to be understood that the poppet stem 11, and the poppet 10 operate in conjunction with the valve port 9 and this operation is distinguished from a ‘spool’ type valve configuration also known to the art. The poppet type closure element differs from the spool type in that it effects a “leak free” seal by contact between the poppet and the seat whereas the spool type closure is a controlled clearance between the spool and the sleeve which allows a certain amount of leakage as dictated by the spool/sleeve clearance amount. The spool type closes and opens different ports in the sleeve to achieve directional change of the fluid flow. The poppet type shuts-off flow and fluid directional change (or stoppage) is accomplished by port locations within the manifold. As is understood from the several drawing figures, the bias spring 19 is generally helical in configuration, is concentric with the poppet stem 11 and is positioned between a flange 17A of the poppet nut 17 at one end thereof, and at its other end, an abutment 16H above the poppet sidewall 16D. Exterior of the pressure relief spring retainer 21 and within the housing interior 13A is provided the pressure relief spring 20, which has one (proximal) end 20A of which engages against one or more (optional) shim washers 23 within the housing interior 13A which when present are at the underside of the housing top wall 13B. The provision of one or more shim washers 23 allows for degree of adjustability in the compressive force of the pressure relief spring 20, but while preferably present, are not essential. With respect to these shim washers 23 as depicted in FIGS. 1A-1D, 2, 3A-3D, they include a central bore 23A sized to accommodate the retainer stop 22 which may enter into the central bore 23A, permitting a part of the retainer stop 22 to contact an underside face 13D of the housing top wall 13B. However, the shim washers 23 may lack a central bore 23A as seen in FIG. 4, if unneeded, or where an adjustment plunger 40 as discussed with reference to FIG. 5 is present. The opposite (distal) end 20B of the pressure relief spring 20 engages against a bottom flange 21A of the pressure relief spring retainer 21. Optionally but preferably, as is seen in FIGS. 1A-1D, as well as in FIG. 2, a pressure relief spring retainer stop 22 is further present, extending in a proximal direction from a top end face 21B of the pressure relief spring retainer 21. In operation, the pressure relief spring retainer stop 22 limits the motion of the pressure relief spring retainer 21 between a maximum, proximal (upward) placement, and the maximum distal (downward) placement, as the dimension, viz., ‘height’ of the pressure relief spring retainer stop 22 would cause it to abut against one or more (optional) shim washers 23 within the housing interior 13A if present, or against the underside face 13D of the housing top wall 13B.

Further visible in the drawing figures is thermal actuator 12, here in the form of a helical coil present within the upper cavity 7, and a part of which extends into the housing 13. One (distal) end 12B of the helically coiled thermal actuator 12 abuts against an abutment face 10A of the poppet 10, and the other (proximal) end 12A of the helically coiled thermal actuator 12 extends and abuts against, an abutment surface 16I of the poppet guide 16. Notwithstanding the depiction in the figures, the shape of the thermal actuator 12 may be of a different geometrical configuration and may indeed any other shape, which is operative and provides a similar function within the manifolds/valves taught herein. Helical geometry is not a limitation, merely a preference.

FIG. 2 provides an enlarged view of the poppet 10, poppet stem 11, housing 13, pressure relief spring retainer 21, and further elements described above with reference to FIGS. 1A-1D.

The operation of the embodiment of the heat responsive control manifold 1 will be discussed with reference to its use with a further device, namely wherein ports 5, 6 are connected to a heat exchanger (not illustrated) in particular, wherein port 6 is in full connection to an inlet side of the heat exchanger, and port 5 is connected to an outlet side of the heat exchanger through which a fluid is supplied to the heat responsive control manifold 1 (or 1A). In this configuration, the heat responsive control manifold 1 may be used to bypass the heat exchanger during system warm up via an open valve port, thereby allowing the fluid to reach normal operating temperature more quickly and afterwards, after fluid reaches normal operating temperature (i.e. 80° C., approx. 175° F.) the valve port is closed thus causing fluid to circulate through the heat exchangers so to maintain a desired operating temperature (i.e. 93.5° C., approx. 200° F.). The heat responsive control manifold 1 remains in this state until the heat exchanger is shut down after which the fluid cools and the valve port 9 of the heat responsive control manifold 1 re-opens for the next start-up cycle. In addition to the foregoing, the heat responsive control manifold 1 also provides a pressure relief function (configuration) which may protect the heat responsive control manifold 1 from excess pressure within the heat responsive control manifold 1 imparted by a fluid which may take place in the event of a blocked (blocked flow) heat exchanger. In this event, the poppet 10 will open the valve port 9 for inlet pressures (i.e., above 25 psid) relieving pressure back to the outlet port.

It is to be understood that the foregoing operational parameters, namely temperatures are pressure are only for the purposes of illustration and are not by way of limitations. The careful selection of the sizes and compressive characteristics of the bias pressure spring 19, the pressure relief spring 20 and the operating characteristics of the thermal actuator 12 may be varied and the combination of these components may selected to provide a desired mode of operation suited to a particular technical need.

The operational temperatures and pressures of the heat responsive control valves and heat responsive control manifolds according to the invention are understood then to have wide applicability. The differential pressure across the poppet when open, its dimensions, its seat diameter and pressure drop across the two ports of the heat responsive control valves and across two or more of the ports of the heat responsive control manifold also play a role in the operational characteristics, particularly the rapidity of response in opening and/or closing the popped against the seat. Optimization of their dimensions can be established by routine experimentation or by empirical methods. From the foregoing it understood that the temperatures and operating pressures discussed herein, specifically with reference to the drawing figures are non-limiting examples. Pressures as low as 0 bar in one or both of the upper cavity 7 and/or the lower cavity 8 are possible, at suitable temperatures of the fluid, or flowable liquids within the heat responsive control valve and heat responsive control manifold.

Valves having controls which are based on wax type actuators are known in the prior. Their operation depends upon the phase changes in the wax and transition from a solid form to a liquid form. While such wax type actuators are useful in many applications and devices, as compared to actuators which are based on a shape-memory metal alloy, particularly where it is Nitinol, the latter have been tested and are known to have up to a 10× faster response time than other thermal actuation technologies, including wax type actuators. This provides higher efficiency and optimal related component sizing in performing a heating cooling function.

The heat response control valves/heat responsive control manifolds of the present invention may be used with other equipment and apparatus, and are not limited to their use with heat exchangers which function with a fluid. Non-limiting examples of such further equipment and apparatus include chemical process equipment, fluid (gas, and liquid) control systems and apparatus, and others. Other functions which may be provided by the heat response control valves/heat responsive control manifolds of the present invention, in addition to those described hereinafter include: thermal shut-off instead bypass, thermal protection instead of bypass, thermal regulation instead of bypass, thermal mixing.

The heat responsive control manifold 1, during operation, may assume our different operational configurations, or ‘operating states’ in response to thermal and pressure conditions present within the heat responsive control manifold 1.

The following descriptions of the operation of the embodiments of the invention are to be understood as being merely exemplary as to operational parameters, particularly temperatures and pressures.

FIG. 1A is representative of the “first operating state” of the heat responsive control manifold 1, and wherein ports 5, 6 are connected to a heat exchanger (not illustrated) in particular, wherein port 6 is in full connection to an inlet side of the heat exchanger, and port 5 is connected to an outlet side of the heat exchanger. A fluid passes through one or more of the ports of the heat responsive control manifold 1. Further, port 4 is connected to a fluid inlet and port 3 is connected to a fluid outlet. In this state, the open valve port 9, is ‘open’ as not being sealed by the poppet 10 which allows for the inlet of fluid from port 4, to enter the lower cavity 8, pass through the valve port 9 and exit the heat responsive control manifold 1 via port 3. In this example, this state occurs to a first operating temperature, (i.e., 60° C., about 140° F.) and where there is a low pressure differential between the upper cavity 7 and the lower cavity 8 of the body 2. (i.e. 0.55 bar, about 8 psi). Again, these operational characteristics are for the purpose of the example, and are not to be understood as being limiting of the invention. In this state, the bias spring 19 and the inlet pressure is sufficient to compress the helically coiled thermal actuator 12 which remains flexible as its shape-memory alloy is being in a martensite phase, thus causing the poppet 10 to be retracted into the interior of the upper cavity 7 and away from the valve port 9, opening it. In this state, the force of the pressure relief spring 20 is greater than the combined forces of the bias spring 19 and the inlet pressure within the lower cavity 8 of the body 2. It should be observed that the relative position of the poppet 10 and the poppet stem 11 relative to the poppet guide 16 is such no gap G is formed between the distal end of the poppet guide 16C and the larger diameter region 11D of the poppet stem 11. This ensures a fixed position of the poppet guide 16 and the poppet stem 11 and the poppet 10 relative to one another, and do not move separately. Concurrently a gap K is present between the poppet nut 17, and the poppet guide 16. In this state, the flow path of fluid (as represented by arrows labeled “F”) within the body 2 is substantially from the inlet port 4, through the lower cavity 8, then the upper cavity 7 and out through the outlet port 3. The foregoing may also be described as a ‘first operational configuration’.

FIG. 1B is representative of the “second operating state” of the heat responsive control manifold 1, of prior FIG. 1A. In this second state, the fluid temperature is at a higher temperature than before (i.e., 80° C., approx. 175° F.) and there remains a low pressure differential between the upper cavity 7 and the lower cavity 8 of the body 2 (i.e. 0.55 bar, about 8 psi) as in prior FIG. 1A. At this higher temperature, but still low pressure differential, the thermal actuator 12 now changes from its prior, martensite phase and the atoms arrange themselves into a cubic, highly symmetrical arrangement characteristic of the austenite phase of the shape-memory alloy. At these conditions, the dimension of the thermal actuator is in its maximum extended length, which is limited by the available distance between the poppet guide abutment surface 16I and the poppet abutment face 10A. This moves the poppet 10 and poppet stem 11 in the distal direction, away from the housing 13 and urges the poppet 10 to seal the valve port 9 thus denying direct passage of fluid directly between lower cavity 8 of the body 2, via the valve port 9 into the upper cavity 7 of the body 2. This is depicted in FIG. 1B with the various arrows labeled “F” representing the direction of fluid flow which now only permits for crossflow between port 4 and 6, and separate crossflow between ports 3 and 5. Thus, fluid entering via port 4 necessarily passes into the heat exchanger via port 6, and returns from the heat exchanger, entering the body 2 via port 5, and thereafter exits the heat responsive control manifold 1 via port 3. In this state, the force of the pressure relief spring 20 is greater than that of the thermal actuator 12 and allows the thermal actuator 12 to extend to its maximum possible extent, between its proximal end 12A abutting the abutment surface 16I of the poppet guide 16, and its distal end 12B abutting the abutment face 10A of the poppet 10. It should be observed that the relative position of the poppet 10 and the poppet stem 11 relative to the poppet guide 16 is such that a gap G is formed between the distal end of the poppet guide 16C and the larger diameter region 11D of the poppet stem 11. Concurrently, essentially a small gap K is present between the poppet nut 17, and the poppet guide 16. The foregoing may also be described as a ‘second operational configuration’.

FIG. 1C is representative of the “third operating state” of the heat responsive control manifold 1, of prior FIG. 1A. In this state, as compared to prior FIG. 1B, the fluid temperature is at a second and still higher temperature than before (i.e., 93.5° C., approx. 200° F.) while there remains a low pressure differential between the upper cavity 7 and the lower cavity 8 of the body 2 (i.e. 0.55 bar, about 8 psi) as in prior FIGS. 1A and 1B. In this state, poppet 10 remains urged in order to seal the valve port 9 thus denying direct passage of fluid directly between lower cavity 8 of the body 2, via the valve port 9 into the upper cavity 7 of the body 2. In this third state, no gap K is present between the poppet nut 17, and the poppet guide 16, which are now in abutment, and thus prevents any further expansion of the thermal actuator 12 and also pre-loads the pressure relief spring 20. In this “third operating state” the thermal actuator is rigid, and maintains the maximum separation (distance) between the poppet 10 and the poppet guide 16. As in FIG. 1B, fluid entering via port 4 necessarily passes into the heat exchanger via port 6, and returns from the heat exchanger, entering the body 2 via port 5, and thereafter exits the heat responsive control manifold 1 via port 3, as is represented by the separate arrows labeled “F”. The foregoing may also be described as a ‘third operational configuration’.

FIG. 1D is representative of the “fourth operating state” of the heat responsive control manifold 1, which also depicts the arrangement of the elements of the heat responsive control manifold 1 when an overpressure exists within the body 2, namely between the upper cavity 7 and the lower cavity 8. In the depicted figure, the fluid temperature within the body 2 is sufficiently high to ensure that the thermal actuator 12 remains in its expanded condition between the poppet 10 and the poppet guide 16, i.e., is 93.5° C., approximately 200° F. or greater, thus ensuring that the no gap K is present between the poppet nut 17 and the poppet guide 16 which prevents any further expansion of the thermal actuator 12 and this ensures that the poppet 10 is extended outwardly and distally from the poppet guide 16 to its maximum possible extent, and the gap G is retained at its largest dimension as well. Concurrently, when the overpressure exists within the body 2, which threshold is governed by the compressive characteristics of the pressure relief spring 20, the end to end dimension of the pressure relief spring 20 is reduced, viz, compressed allowing for pressure relief spring retainer 21 to move in a proximal direction and away from the valve port 9, which removes the poppet 10 from it fluid sealing position and allowing for the flow of fluid from the lower cavity 8 of the body 2, via the valve port 9 into the upper cavity 7 of the body 2,

As is seen from FIG. 1D, the pressure relief spring retainer 21 may move until its further proximal axial movement is blocked, i.e., such as may occur when the pressure relief spring retainer stop 22 abuts against the underside of the housing top wall 13B. The overpressure pressure within the body 2, which would trigger the above fourth operating state may be any which would be useful in mitigating risk to either the heat responsive control manifold 1, or to a device or apparatus to which such as heat responsive control manifold 1 is attached to and is in fluid communication therewith. By way of non-limiting example, an overpressure within the body 2, which would trigger the above fourth operating state. The overpressure may be virtually any desired pressure within the body as desired in a particular application, namely pressure at which the relief spring force is less than the force of the thermal actuator. The overpressure pressure may be established by careful selection of the operational characteristics (including but not limited to compression pressure, temperature response, etc.) of one of more of the thermal actuator 12, the bias spring 19, and the pressure relief spring 20. Upon sufficient cooling or reduction of pressure below the relief pressure within the body, the heat responsive control manifold 1, may assume one of the first, second or third states as previously described. The foregoing may also be described as a ‘fourth operational configuration’.

FIG. 2 depicts in an enlarged view of certain elements of the heat responsive control manifold 1 of FIGS. 1A-1D, which may provide a better appreciation of the arrangement of the interrelationship of the housing 13, poppet guide 16, poppet nut 17, pressure relief spring retainer 21, pressure relief spring retainer stop 22, pressure relief spring 20, bias spring 19, thermal actuator 12, poppet stem 11 and poppet 10. Seen in this further detail are two further features of this preferred embodiment. A first feature is the provision of namely two vents 24 passing through a part of the poppet guide 16, permitting for fluid flow, which may be a liquid or gas or both, to enter the interior of the housing 13 and particularly the interior of the pressure relief spring retainer 21 from the upper cavity 7. One or more vents 24 provide for ensuring pressure balances within the internal components so that there is no differential pressure force affecting the balance of forces operating on the popped 10 and the thermal actuator 12. While two vents 24 are depicted, such is optional but preferred and further one, two or more such vents 24 may be present. As second feature is that of a retainer vent 25, which may simply be a passage or bore extending into the interior of the pressure relief spring retainer 21 from within the housing 13, via the pressure relief spring retainer stop 22 when one such is present. In the case where no pressure relief spring retainer stop 22 is present, a bore or passages 26 extending through any part of the pressure relief spring retainer 21 from within the housing 13, such as the top end face 21B, or through the pressure relief spring retainer sidewall 21C would be satisfactory.

FIGS. 3A-3D depict a preferred embodiment of a heat responsive control valve 1A according to the invention. It is to be noted that the heat responsive control valve 1A closely corresponds to the heat responsive control manifold 1 as disclosed and discussed with reference to prior drawing FIGS. 1A-1D, 2 and differs primarily only in that the heat responsive control valve 1A omits ports 5,6 from the body 2. All other features and elements are however the same, and operate in substantially the same manner as has been discussed with reference to FIGS. 1A-1D, and 2. Each of the drawings 3A, 3B, 3C, and 3D different operational states of the heat responsive control valve 1A at different temperature and pressure conditions, as has been correspondingly described in counterpart drawing FIGS. 1A, 1B, 1C and 1D.

With regard to the operation of the heat responsive control valve 1A, its operation is substantially the same as has been described with reference to the heat responsive control manifold 1. The operation of the embodiment of the heat responsive control valve 1A will be discussed with reference to its use with a further device, but wherein ports 5, 6 are absent so that there is not a crossflow feature provided, such as has been discussed with reference to FIGS. 1B, 1C wherein fluid may pass transversely only between ports connected to the upper cavity 7 or between ports connected to the lower cavity 8.

FIG. 3A (which closely corresponds to FIG. 1A) is representative of the “first operating state” of the heat responsive control valve 1A, but in this embodiment, ports 5, 6 are absent. In FIG. 3A, port 4 is connected to a fluid inlet and port 3 is connected to a fluid outlet. In this state, the open valve port 9, is ‘open’ as not being sealed by the poppet 10 allows for the inlet of fluid from port 4, to enter the lower cavity 8, pass through the valve port 9 and exit the heat responsive control valve 1A. This state occurs to a first operating temperature, (i.e., 60° C., about 140° F.) and where there is a low pressure differential between the upper cavity 7 and the lower cavity 8 of the body 2 (i.e., 0.55 bar, about 8 psi). In this state, the bias spring 19 and the inlet pressure is sufficient to compress the helically coiled thermal actuator 12 which remains flexible as its shape-memory alloy is in a martensite phase, thus causing the poppet 10 to be retracted into the interior of the upper cavity 7 and away from the valve port 9, opening it. In this state, the force of the pressure relief spring 20 is greater than the combined forces of the bias spring 19 and the inlet pressure within the lower cavity 8 of the body 2. It should be observed that the relative position of the poppet 10 and the poppet stem 11 relative to the poppet guide 16 is such that essentially no gap G is formed between the distal end of the poppet guide 16C and the larger diameter region 11D of the poppet stem 11. Concurrently a gap K is present between the poppet nut 17, and the poppet guide 16. In this state, the flow path of fluid (as represented by arrows labeled “F”) within the body 2 is substantially from the inlet port 4, through the lower cavity 8, then the upper cavity 7 and out through the outlet port 3. The foregoing may also be referred to as a ‘first operational configuration’.

FIG. 3B is representative of the “second operating state” of the heat responsive control valve 1A, of prior FIG. 3A. In this second state, the fluid temperature is at a higher temperature than before (i.e., approx. 175° F.) and there remains a low pressure differential between the upper cavity 7 and the lower cavity 8 of the body 2 (i.e. 0.55 bar, about 8 psi) as in prior FIG. 3A. At this higher temperature, but still low pressure differential, the thermal actuator 12 now changes from its prior, martensite phase and the atoms arrange themselves into a cubic, highly symmetrical arrangement characteristic of the austenite phase of the shape-memory alloy. This moves the poppet 10 and poppet stem 11 in the distal direction, and urges the poppet 10 to seal the valve port 9 thus denying direct passage of fluid directly between lower cavity 8 of the body 2, via the valve port 9 into the upper cavity 7 of the body 2. No fluid passes between the upper cavity 7 and the lower cavity 8. In this state, the force of the pressure relief spring 20 is greater than that of the thermal actuator 12, thus permitting the thermal actuator 12 to extend fully without compressing the pressure relief spring 20. It should be observed that the relative position of the poppet 10 and the poppet stem 11 relative to the poppet guide 16 is such that a gap G is formed between the distal end of the poppet guide 16C and the larger diameter region 11D of the poppet stem 11. Concurrently, essentially a small gap K is present between the poppet nut 17, and the poppet guide 16. The foregoing may also be referred to as a ‘second operational configuration.’

FIG. 3C (which closely corresponds to FIG. 1C) is representative of the “third operating state” of the heat responsive control valve 1A, of prior FIG. 3A. In this state, as compared to prior FIG. 3B, the fluid temperature is at a second, higher temperature than before (i.e., 93.5° C., approx. 200° F.) while there remains a low pressure differential between the upper cavity 7 and the lower cavity 8 of the body 2 (i.e. 0.55 bar, about 8 psi) as in prior FIGS. 1A and 1B. In this state, poppet 10 remains urged in the distal direction in order to seal the valve port 9 thus denying direct passage of fluid directly between lower cavity 8 of the body 2, via the valve port 9 into the upper cavity 7 of the body 2. In this third state, no gap K is present between the poppet nut 17, and the poppet guide 16 which prevents any further expansion of the thermal actuator 12 and also pre-loads the pressure relief spring 20. In this “third operating state” the thermal actuator is rigid, and maintains the maximum separation (distance) between the poppet 10 and the poppet guide 16. As in FIG. 3B, no fluid passes between the upper cavity 7 or lower cavity 8. The foregoing may also be referred to as a ‘third operational configuration.’

FIG. 3D (which closely corresponds to FIG. 1D) is representative of the “fourth operating state” of the heat responsive control valve 1A, which also depicts the arrangement of the elements of the heat responsive control valve 1A when an excess or “cracking” pressure exists within the body 2, namely between the upper cavity 7 and the lower cavity 8. In the figure, the fluid temperature within the body 2 is sufficiently high to ensure that the thermal actuator 12 remains in its expanded condition between the poppet 10 and the poppet guide 16, i.e., 93.5° C., or approximately 200° F. or greater, thus ensuring that no gap K is present between the poppet nut 17 and the poppet guide 16, which are now in abutment, and which prevents any further expansion of the thermal actuator 12 and this ensures that the poppet 10 is extended outwardly and distally from the poppet guide 16 to its maximum possible extent, and the gap G is retained at its largest dimension as well. Concurrently, when the overpressure pressure exists within the body 2, which threshold is governed by the compressive characteristics of the pressure relief spring 20, the end to end dimension of the pressure relief spring 20 is reduced, viz, compressed allowing for pressure relief spring retainer 21 to move in a proximal direction and away from the valve port 9, which removes the poppet 10 from it fluid sealing position and allowing for the flow of fluid from the lower cavity 8 of the body 2, via the valve port 9 into the upper cavity 7 of the body 2, As is seen from FIG. 3D, the pressure relief spring retainer 21 may move until its further proximal and axial movement is blocked, i.e., such as may occur when the pressure relief spring retainer stop 22 abuts against the underside face 13D of the housing 13. The excess or overpressure within the body 2, which would trigger the above fourth state may be any which would be useful in mitigating risk to either the heat responsive control valve 1A, or to a device or apparatus to which such as heat responsive control valve 1A is attached to and is in fluid communication therewith. By way of non-limiting example, an excess or overpressure within the body 2, which would trigger the above fourth state may be as little as an excess of about 10% of the normal operating pressure of the heat responsive control valve 1A. Generally however a value of about 50%-250% (or even greater) may be suitable. By way of a non-limiting example, the excess or overpressure within the body 2 of FIG. 3D may be about 1.35-30 bar, approx. 20-30 psi. Upon sufficient cooling or reduction of pressure below the relief pressure within the body, the heat responsive control valve 1A, may assume one of the first, second or third states as previously described. The foregoing may also be referred to as a ‘fourth operational configuration.’

FIG. 4 depicts an alternative view of certain elements which may used with any embodiment of a heat responsive control manifold such as illustrated on FIGS. 1A-1D, or with a heat responsive control valve 1A of FIGS. 3A-3D, and FIG. 4 which may provide a better appreciation of the arrangement of the interrelationship of the housing 13, poppet guide 16, poppet nut 17, pressure relief spring retainer 21, pressure relief spring 20, bias spring 19, thermal actuator 12, poppet stem 11 and poppet 10. The features of FIG. 4 are substantially the same as in the prior FIGS. 1A through 3D, and especially as discussed in FIG. 2, but differ, in that (a) no pressure relief spring stop 22 is present depending from the top end face 21B of the pressure relief spring retainer 21, (b) no poppet stem cavity 13C is present, and (c) in addition to, or in place of the vents 24 as illustrated in FIG. 2. In this FIG. 4 two vents 24 are depicted, here passing through the pressure relief spring retainer sidewall 21C. However, as noted with respect to FIG. 2, such is optional although also preferred, and when present, it is also to be understood that one, two or more such vents 24 may be present.

FIG. 5 depicts a further alternative view of certain elements which may used with any embodiment of a heat responsive control manifold such as illustrated on FIGS. 1A-1D, or with a heat responsive control valve 1A of FIGS. 3A-3D to adjust the relief pressure. The embodiment of FIG. 5 is in many respects similar to that of FIG. 4, but in FIG. 5, the shim washers 23 are omitted, and replaced by an adjustment plunger 40, having a stem 40A, a proximal adjustment end 40B at its opposite or distal end, a plunger head 40C, which may be integral or may be a separate element as shown in the Figure. The plunger 40C may include a plunger plate 41 as a separate element as shown in FIG. 5, but in an alternative the plunger plate 41 may be integral to the adjustment plunger 40 whose plunger head 40C may be configured to operate as a plunger plate. The plunger plate 41 comprises an abutment flange 41A within the housing interior 13A against which an end, here the proximal end 20A abuts, while the opposite end, namely the distal end 20B abuts against the relief spring retainer bottom flange 21A. The embodiment of this FIG. 5 operates in a manner closely corresponding to that discussed with reference to FIG. 4, but provides for an ability to adjust the compression of the pressure relief spring 20 without requiring any disassembly. Namely the housing includes and extending a plunger guide 42 depending from an extending from the housing top wall 13B. The plunger guide 42 includes a guide bore 43 within which the plunger stem 40A is accommodated, and via which the adjustment plunger 40 may be moved in the inwardly or outwardly, or correspondingly into the distal or proximal direction, and further correspondingly compressing or relieving the compression exerted on the pressure relief spring 20 exerted by the adjustment plunger 40. The relative position of the adjustment plunger 40 relative to the guide plunger guide 42 may be established by rotating the adjustment plunger 40, a section of which includes threads, viz, plunger threads 43A which engage corresponding threads, viz., plunger guide threads 43B. One or more adjustment plunger seals 44, here provided as an O-ring, is advantageously included to ensure proper operation of the apparatus.

It is to be understood that parts of the assemblage of FIGS. 2, 4, 5, 6A and 6B may be used interchangeably and may be included within any of the embodiments of the heat responsive control manifold such are disclosed and described in FIGS. 1A-1D, and/or with a heat responsive control valve 1A such are disclosed and described with reference to FIGS. 3A-3D.

1. A heat responsive control valve comprising a body having at least one interior upper cavity, at least one interior lower cavity and a valve port intermediate the cavities, a fluid input port and a fluid output port in fluid communication with at least one of the cavities, a retractable poppet stem having at or near one end, a poppet nut, and at or near another end, a poppet which when the poppet is engaged against the valve port closes the valve port, housing, a poppet guide moveable within the housing, the poppet guide having poppet guide bore within which the poppet stem is slidably engaged, a thermal actuator between the poppet and the poppet guide, and further within the housing, a pressure relief spring, a relief spring retainer, and a bias spring, wherein the bias spring is moveable within the interior of the relief spring retainer and is present between the poppet guide and the poppet nut, the pressure relief spring is moveable within the housing and is present between the exterior of the relief spring retainer and the housing, which heat responsive control valve, may under different internal temperature and pressure conditions, assume one of four different operational configurations, and during operation provides an integral overpressure relief function, and may be configured in response to an overpressurized state to assume a bypass configuration.

2. A heat responsive control manifold which includes a heat responsive control valve according to claim 1, which further includes more than one fluid input and/or more than one fluid output to one or more of the at least one interior upper cavity, and/or the at least one interior lower cavity, and wherein the one or both of the at least one upper cavity and/or the at least one lower cavity is in fluid communication with two fluid ports, and, may under different internal temperature and pressure conditions, assume one of four different operational configurations, and during operation provides an integral overpressure relief function, and in response to an overpressurized state may assume a bypass configuration.

3. A method of controlling a flow of fluid utilizing a heat responsive control valve according to claim 1.

4. A method of controlling a flow of fluid utilizing a heat responsive control manifold according to claim 2.

5. A heat responsive control valve according to claim 1 wherein the housing includes a plunger guide, and a moveable adjustment plunger.

6. A heat responsive control manifold according to claim 2 wherein the housing includes a plunger guide, and a moveable adjustment plunger.

7. An apparatus comprising, or an apparatus which operates with, a heat responsive control valve according to claim 1.

8. An apparatus comprising, or an apparatus which operates with, a heat responsive control valve manifold according to claim 2.
